(19) United States
(12) Patent Application Publication
(10) Pub. No.: US 2026/0189002 A1
(43) Pub. Date: Jul. 2, 2026

(54) SYSTEM AND METHOD FOR IDENTIFYING ATYPICAL CONDITIONS IN COMPOUND ENERGY STORAGE SYSTEMS

(71) Applicant: FLUENCE ENERGY, LLC, Arlington, VA (US)

(72) Inventors: Thomas Jeffrey WINTER, Decatur, GA (US); Brett Lance GALURA, Vienna, VA (US)

(73) Assignee: FLUENCE ENERGY, LLC, Arlington, VA (US)

(21) Appl. No.: 18/867,694

(22) PCT Filed: Sep. 20, 2024
(86) PCT No.: PCT/US2024/047664

§ 371 Date: Nov. 20, 2024

Related U.S. Application Data
(60) Provisional application No. 63/539,925, filed on Sep. 22, 2023.

(51) Int. Cl. H02J 3/001; H02J 13/12; H02J 103/30

(52) U.S. Cl. CPC H02J 3/001; H02J 13/12; H02J 2103/30

(57) ABSTRACT

A system includes a plurality of energy storage nodes, a power conversion system (PCS), a plurality of sensors to detector or monitor system data that includes component data from or about one or more components of the energy storage system, and a control and management system. Each of the energy storage nodes include a battery storage element. The component data includes battery data, PCS data, or a combination thereof. Control and management system is configured to receive or store the system data; apply analytical models to system data to predict or identify an atypical condition relating to a weakness, damage, or a changed condition in the one or more components of the energy storage system; and responsive to the atypical condition, optimize a maintenance plan for the energy storage system. Components of the energy storage system can include a battery storage element, a power conversion system, or a transformer.

### CROSS-REFERENCE TO RELATED APPLICATIONS

This application claims priority to U.S. Provisional Patent Application No. 63/539,925, filed on Sep. 22, 2023, titled “System and Method for Identifying Atypical Conditions in Compound Energy Storage Systems,” the entire disclosure of which is incorporated by reference herein.

### TECHNICAL FIELD

The present subject matter relates to energy storage systems that include a plurality of energy storage nodes and predicting or identifying an atypical condition relating to a weakness, damage, or a changed condition in one or more components of the energy storage system. The present subject matter also encompasses responsive to the atypical condition, optimizing a maintenance plan for the energy storage system responsive to the atypical condition.

### BACKGROUND

An energy storage system, such as a battery energy storage system (BESS), can be set up in a distributed manner to satisfy safety and economical concerns. The energy storage system often includes many energy storage nodes that each include an enclosure that houses many batteries inside. Typically, the energy storage system includes a control system that monitors the energy storage nodes.

Generally, the components of current state of the art battery energy storage system are maintained under two types of service schedules. First, some components are serviced on a pre-set schedule that is time-based. Time-based service includes events, such as regularly scheduled inspections, for example a multi-point inspection of an inverter, with repair and replacement of atypical out-of-tolerance components and sub-components based on the results of one of the regularly scheduled inspections. Time-based service also includes events, such as scheduled replacement or service of components and sub-components. In particular, time-based service is for components which are difficult to find fault with during an inspection, as well as components which can have outsized failure costs for the energy storage system as compared to the cost of simply replacing the component, such as an emergency shut-off breaker. Second, some components are serviced on a break-fix basis, where the component first fails and is then repaired or replaced outside of regularly scheduled inspections or maintenance. Failure-based service is used in particular for components which rarely fail, and the cost of failure is relatively small to the energy storage system as compared to the cost of inspecting, repairing, or replacing the component.

Both of these strategies incur overhead costs. Time-based service can result in extraneous inspections as well as extraneous component repair or replacement. Inspections may uncover that the inspected components are operating nominally, and that no part requires repair or replacement. Scheduled component repair or replacement may be performed on components that have reached an expected end-of-life, but not a functional end-of-life—particularly when environmental conditions drastically impact functional end-of-life, and the expected end-of-life is determined conservatively, based upon harsh conditions that the particular component does not experience in use. Break-fix service can result in service performed outside of a normal scheduled maintenance window, which creates additional costs, as unplanned site visits, travel, and potentially rush-delivering components may occur. This is a particular problem for energy storage systems deployed in remote areas. The energy storage system will also likely suffer reduced performance until the broken component can be repaired or replaced.

Additionally, these strategies are often both employed on the same energy storage system. Some components in an energy storage system are serviced on a schedule, while some components are serviced as they break. Therefore, a given site can incur both the overhead costs of scheduled service, as well as the overhead costs of break-fix service. Further, in spite of following a rigorous regular scheduled maintenance regimen, regularly maintained components can still fail outside of their regularly scheduled maintenance period, nevertheless resulting in a break-fix repair or replacement.

### SUMMARY

Hence, there in a need for technologies to identify defects or other atypical conditions of components of an energy storage system. The technologies described herein can identify an atypical condition related to a weakness, damage, or a changed condition of components with a level of certainty or predictive nature to provide insights into component maintenance. Based on those insights, the technologies enable creation of threshold and logic to programmatically decide which proactive maintenance activities can be performed to maximize outcomes, such as increased energy storage system performance, reduced cost of servicing, and improved reliability.

In a first example, an energy storage system 101 includes a plurality of energy storage nodes 105A-N. Each of the plurality of energy storage nodes 105A-N include a battery storage element 106. The energy storage system 101 further includes a power conversion system (PCS) 104; and a plurality of sensors 164A-N, 168A-N, 315A-N, 370A-N, 375A-N to detect or monitor various system data 380A-N. The system data 380A-N includes component data 381A-N from or about one or more components 104, 106-108, 152-156, 205, 210, 215 of the energy storage system 101. The component data 381A-N includes battery data 111A-N, PCS data 157A-N, or a combination thereof. The energy storage system 101 further includes a control and management system 115 coupled to the plurality of energy storage nodes 105A-N, the PCS 104, and the plurality of sensors 164A-N, 168A-N, 315A-N, 370A-N, 375A-N. The control and management system 115 is configured to receive the system data 380A-N and includes a non-transitory computer-readable medium 313, comprising maintenance management programming 330A. Execution of the maintenance management programming 330A by one or more processors 312 configures the control management system 115 to: receive or store the system data 380A-N; apply at least one analytical model 395A-N to the system data 380A-N to predict or identify an atypical condition 396A of a plurality of atypical conditions 396A-N relating to a weakness, damage, or a changed condition in the one or more components 104, 106-108, 152-156, 205, 210, 215, of the energy storage system 101; and responsive to the atypical condition 396A, optimize a maintenance plan 397 for the energy storage system 101.

In a second example, a non-transitory computer-readable medium, 313, 353 includes maintenance management programming 330A-B. Execution of the maintenance management programming 330A-B by one or more processors 312, 352 configures one or more controllers 110, 115, 170-173 to receive or store system data 380A-N. The system data 380A-N includes component data 381A-N from or about one or more components 104, 106-108, 152-156, 205, 210, 215 of the energy storage system 101, the component data 381A-N including battery data 111A-N, PCS data 157A-N, or a combination thereof. Execution of the maintenance management programming 330A-B by one or more processors 312, 352 configures one or more controllers 110, 115, 170-173 to apply at least one analytical model 395A-N to the system data 380A-N to predict or identify an atypical condition 396A of a plurality of atypical conditions 396A-N relating to a weakness, damage, or a changed condition in the one or more components 104, 106-108, 152-156, 205, 210, 215 of the energy storage system 101. Execution of the maintenance management programming 330A-B by one or more processors 312, 352 configures one or more controllers 110, 115, 170-173 to responsive to the atypical condition 396A, optimize a maintenance plan 397 for the energy storage system 101.

In a third example, a method 600, includes receiving or storing system data 380A-N, wherein the system data 380A-N includes component data 381A-N from or about one or more components 104, 106-108, 152-156, 205, 210, 215 of the energy storage system 101. The component data 381A-N includes battery data 111A-N, PCS data 157A-N, or a combination thereof. The method 600 further includes applying at least one analytical model 395A-N to the system data 380A-N to predict or identify an atypical condition 396A of a plurality of atypical conditions 396A-N relating to a weakness, damage, or a changed condition in the one or more components 104, 106-108, 152-156, 205, 210, 215 of the energy storage system 101. The method 600 further includes responsive to the atypical condition 396A, optimizing a maintenance plan 397 for the energy storage system 101.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A depicts a system that includes an energy storage system, energy system, and an electrical application.

FIG. 1B depicts a battery array, an array controller, and core controllers of an example architecture of a control and management system of FIG. 1A.

FIG. 1C depicts the array controller, the core controllers, node controllers, and enclosure controllers in the example architecture of the control and management system of FIGS. 1A-B.

FIG. 1D depicts a power conversion system of a battery core of FIG. 1A-C.

FIG. 2A illustrates a first energy storage node of a plurality of energy storage nodes of the energy storage system of FIGS. 1A-C coupled to the electrical application.

FIG. 2B illustrates a first energy storage node that includes a plurality of battery cubes and a plurality of power conversion systems coupled to a DC link (DC bus).

FIG. 3A is a high-level functional block diagram of the energy storage system of FIG. 1A that depicts components of the control and management system and control subsystem for optimizing maintenance of the energy storage system.

FIG. 3B is another high-level functional block diagram of the energy storage system of FIGS. 1B-C that depicts components of the control and management system with various controllers for optimizing maintenance of the energy storage system.

FIG. 3C is a block diagram of the control system depicting various types of battery conditions to implement the maintenance management protocol of FIGS. 4A-B.

FIG. 4A is a maintenance management protocol for the energy storage system of FIG. 1A that is implemented by the control and management system, the control subsystem, and the plurality of energy storage nodes.

FIG. 4B is the maintenance management protocol for the energy storage system of FIGS. 1B-C that is implemented by the various controllers of the control and management system and the plurality of energy storage nodes.

FIG. 5 is a cutaway view of the first energy storage node of the plurality of energy storage nodes and shows details of a plurality of battery storage elements.

FIG. 6 is a flowchart of a method that can be implemented for optimizing maintenance of the energy storage system.

### PARTS LISTING

100 System
101 Energy Storage System
102 Energy System
103 Electrical Application
104, 104A-N Power Conversion Systems
105A-N Energy Storage Nodes
106, 106A-N Battery Storage Elements
107, 107A-N Power Conversion Subsystems
108 Transformer
109 Energy Source
110 Control Subsystem
111A-N Battery Data
112 Required Power Flow
115 Control and Management System
116A-O Battery Conditions
116A State of Charge (SOC)
120 Physical Space
122 Current
123 Voltage
125 Power Bus
150 Battery Array
151A-N Battery Cores
152 Power Conversion Unit
153 HVAC Equipment
154 Fan
155 Condenser
156 Heater
157A-N PCS Data
160 PCS Controller
161 Network Communication Interface
162 Processor
163 Memory
164A-N Environmental Sensors
165A-N Environmental Condition Data
168A-N PCS Sensors
170 Array Controller
171, 171A-N Node Controllers
172, 172A-N Core Controllers
173, 173A-N Enclosure Controllers
174 Market Dispatch Unit Controller
183, 183A-N Power Commands
205 Power Inverter
210 Rectifier
215 DC-DC Converter
225 DC Link (DC Bus)
230, 230A-N Battery Cubes
250 DC Link Voltage
305, 305A-N Network
311, 351 Network Communication Interface
312, 352 Processor
313, 353 Memory
315A-N Sensors
330, 330A-B Maintenance Management Programming
365A-N Environmental Condition Data
370A-N Environmental Sensors
375A-N Battery Sensors
380A-N System Data
381A-N Component Data
385, 385A-N Mitigation Activities
395A-N Analytical Models
396A-N Atypical Conditions
397 Maintenance Plan
398A-N Time Periods
399A-N Atypical Condition Patterns
400 Maintenance Management Protocol
500 Enclosure
600 Method

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

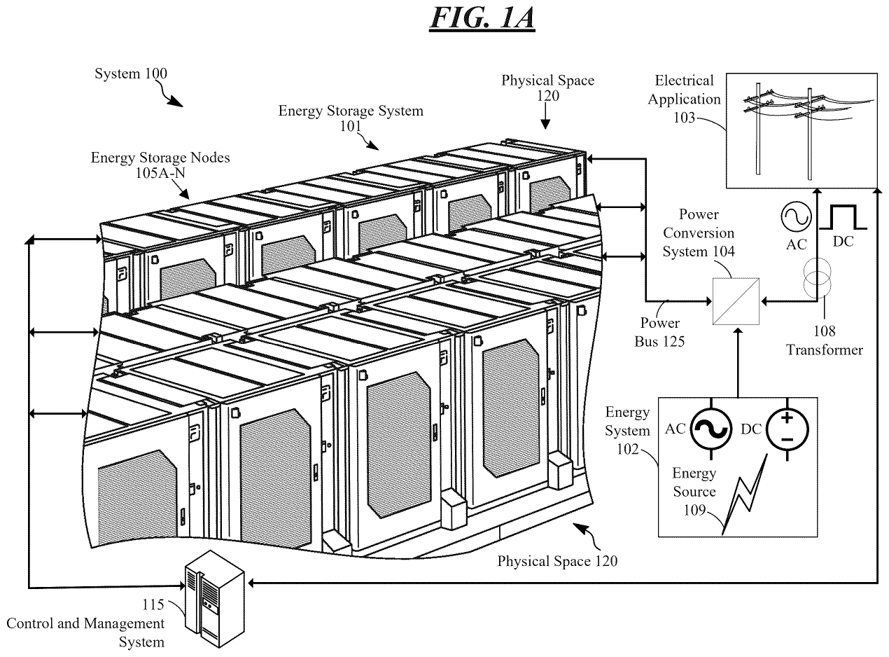

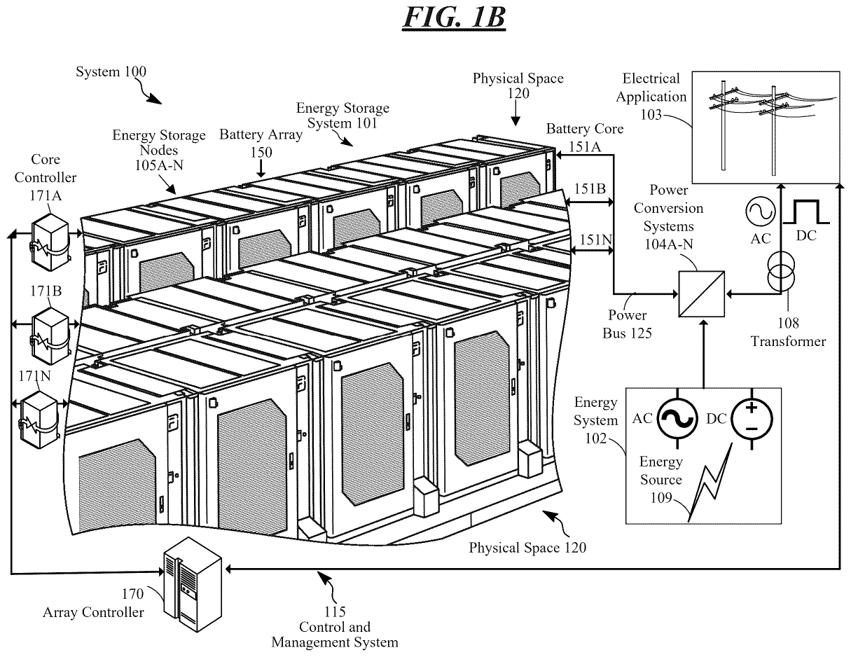

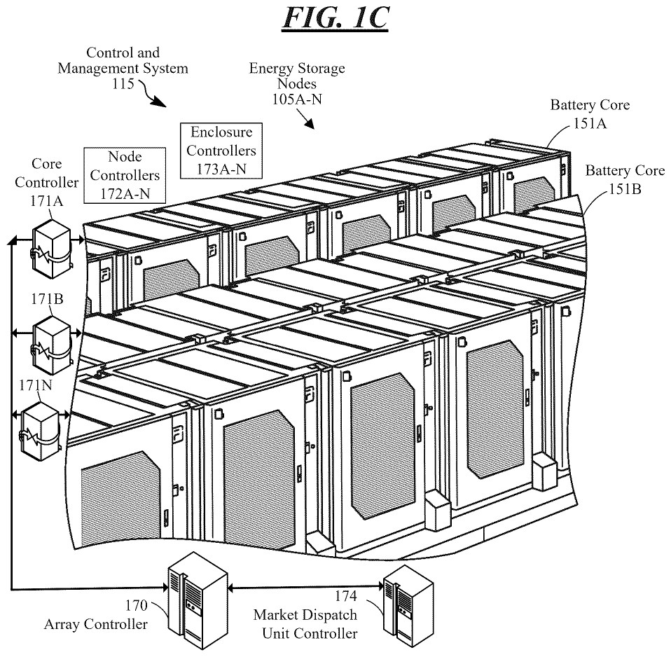

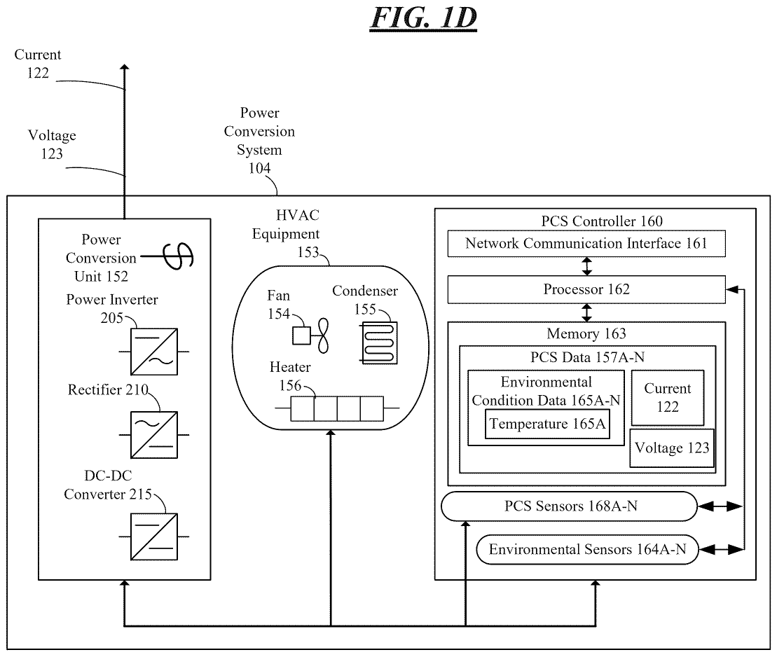

Unless otherwise indicated, any embodiment can be combined with any other embodiment. In particular, FIGS. 1A-6 and the associated text are all combinable with each other.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

Reference now is made in detail to the examples illustrated in the accompanying drawings and discussed below.

FIG. 1A depicts a system 100 that includes an energy storage system 101, energy system 102, and an electrical application 103. FIG. 1B depicts a battery array 150, an array controller 170, and core controllers 171A-N of an example architecture of a control and management system 115 of FIG. 1A.

Referring to both FIGS. 1A-B, for example, the energy storage system 101 can be a battery energy storage system (BESS). The energy storage system 101 is coupled to the energy system 102 and the electrical application 103. Energy storage system 101 can include one or more power conversion systems (PCSs) 104A-N, a plurality of energy storage nodes 105A-N, an optional transformer 108, and a control and management system 115. Components of the energy storage system 101 can be located at a physical space 120 that is outdoors or indoors, for example, inside of a building, a container, or other structure.

Energy storage system 101 comprises a battery array 150 including a plurality of battery cores 151A-N including a first set of battery cores 151A-C and a second set of battery cores 151D-F, for example. Each of the battery cores 151A-N include at least one power conversion system 104A-N. In an example, there can be one PCS 104 and one transformer 108 per battery core 151A-N (at the battery core level).

As described in further detail below, energy storage system 101 can include a control and management system 115 coupled to the energy storage nodes 105A-N and the PCS 104. The control and management system 115 can include one or more controllers 170-174, such as an array controller 170, core controllers 171A-N, node controllers 172A-N, enclosure controllers 173A-N, and a market dispatch unit controller 174. The control and management system 115 is configured to control the battery cores 151A-N to dispatch a required power flow 112.

Power conversion systems 104A-N are coupled to the plurality of energy storage nodes 105A-N. The power conversion systems 104A-N are coupled to the energy system 102 and the electrical application 103 to provide a required power flow 112 to the electrical application 103 by discharging the plurality of energy storage nodes 105A-N or the required power flow 112 from the energy system 102 for charging the plurality of energy storage nodes 105A-N. The power conversion systems 104A-N can be coupled to an optional transformer 108. The optional transformer 108 can step up or step down the required power flow 112 to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow 112 of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology, including, but not limited to lithium ion, flow batteries, or mechanical storage, such as flywheel energy storage, compressed air energy storage, pumped-storage hydroelectricity, gravitational potential energy, or a hydraulic accumulator.

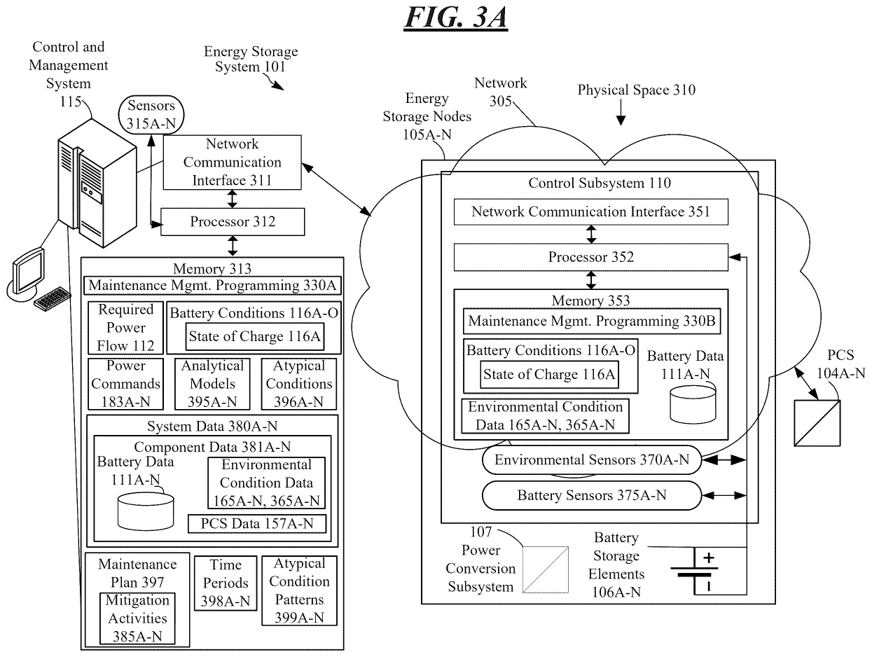

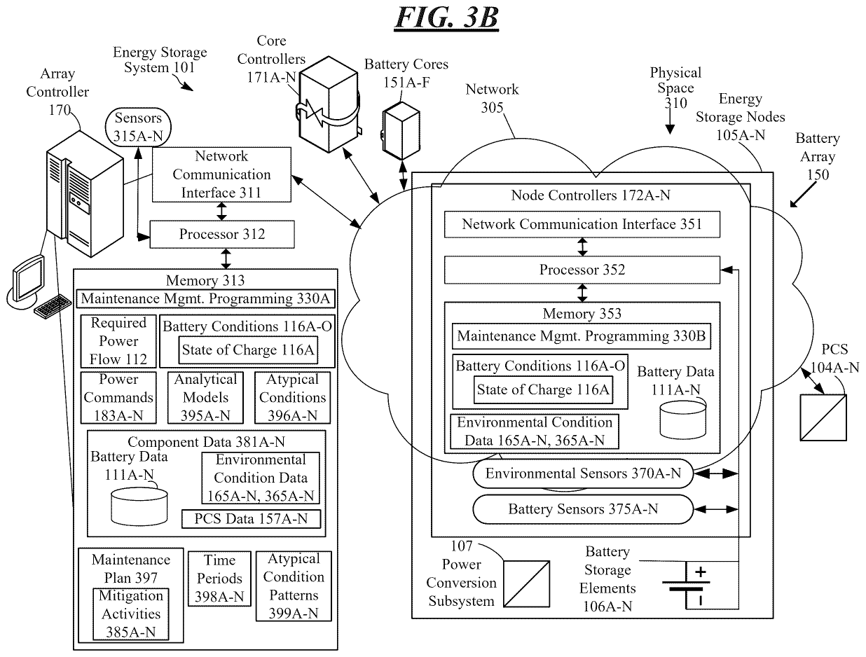

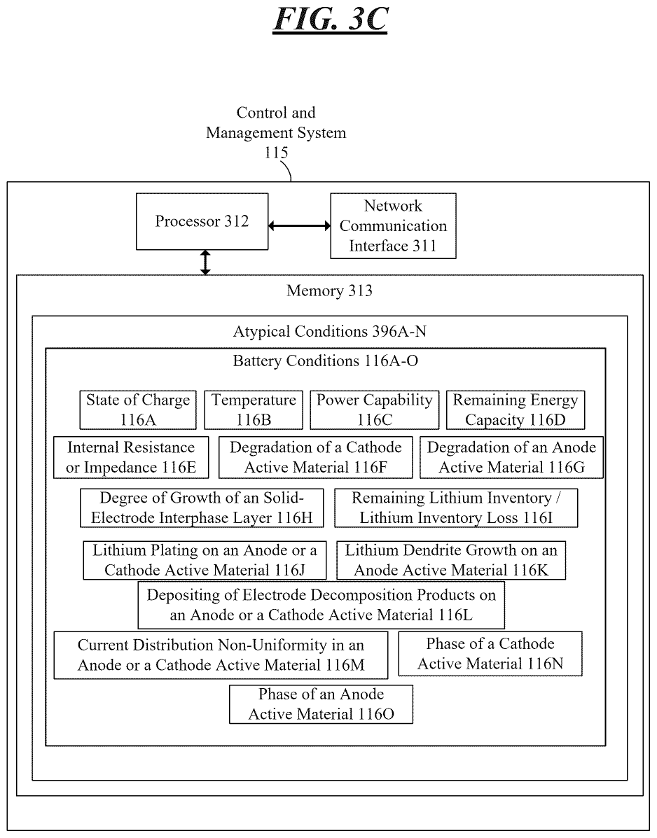

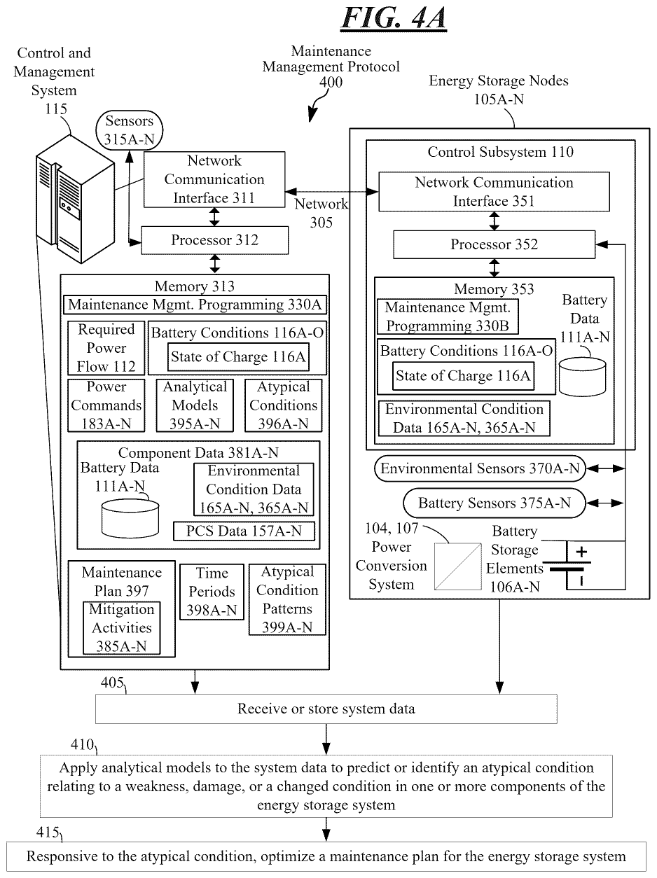

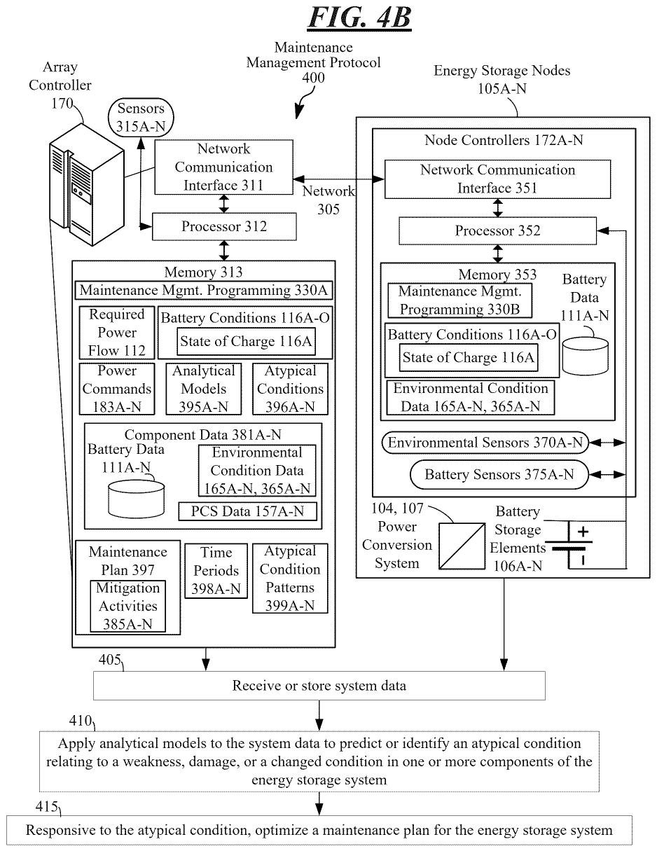

Control and management system 115 implements a maintenance management protocol 400 (see FIGS. 4A-B) which can be implemented in maintenance management programming 330A-B (see FIGS. 3A-B). Typically, components of an energy storage system 101 are serviced in one of two ways: i) on a pre-set schedule that is time based (e.g., service the component every six months), or ii) on a break-fix basis which involves waiting for a component to fail and then servicing it outside of the normal maintenance window. The maintenance management protocol 400 receives or stores system data 380A-N and applies at least one analytical model 395A-N to the system data 380A-N to predict or identify an atypical condition 396A of a plurality of atypical conditions 396A-N relating to a weakness, damage, or a changed condition in the one or more components 104, 106-108, 152-156, 205, 210, 215 of the energy storage system 101. The maintenance management protocol 400 further includes responsive to the atypical condition 396A, optimizing a maintenance plan 397 for the energy storage system 100, for example, with respect to the one or more components 104, 106-108, 152-156, 205, 210, 215.

FIG. 1C depicts the array controller 170, the core controllers 171A-N, node controllers 172A-N, and enclosure controllers 173A-N in the example architecture of the control and management system 115 of FIGS. 1A-B. In the example, each of the energy storage nodes 105A-N can be a collection of one or more battery cubes 230A-N and every battery cube 230A-N includes an enclosure controller 173. A node controller 172 is the lowest controllable element of a battery core 151 for an energy storage node 105A-N and controls an individual energy storage node 105. A core controller 171 is the next higher level, which controls a subset of the energy storage nodes 105A-N, where each core represents branches of components of the energy storage system 101. The core controller 171 is a logical controller and can represent a transformer 108 that stands between the PCS 104 and the rest of the plant. Core controller 171 is an aggregator of different node controllers 172A-N and propagates power commands 183A-N from the array controller 170 to the node controllers 172A-N.

Array controller 170 is higher than the core controllers 171A-N and controls the overall energy storage system 101. The software for the array controller level can be installed at a customer installation site and can execute at the installation site, off-site, or a combination thereof. The array controller 170 can be a local decentralized service that runs onsite in real time.

A market dispatch unit controller 174 is a network wide controller and sits on top of the array controller 170 and looks at specific market requirements. The market dispatch unit controller 174 sets dispatch setpoints in terms of active and reactive power to the array controller 170 which deals with the energy storage system 101.

A battery core 151 can have multiple node controllers 172A-N depending on the number of energy storage nodes 105A-N and bus architecture of the battery core 151. In an example, if the PCS 104 is used as a single bus element, then there may be only one node controller 172 behind a core controller 171 for a single energy storage node 105A and only one PCS 104 per energy storage node 105A. But if the PCS 104 is used with multiple DC connections in a split bus architecture where a plurality of energy storage nodes 105A-D (e.g., four) are connected to the bus, there can be a plurality of energy storage nodes 105A-D on the bus and only one PCS 104 for all of the plurality of energy storage nodes 105A-D.

FIG. 1D depicts a power conversion system 104 of a battery core 151 of FIGS. 1A-C. As shown, the power conversion system 104 can include a power conversion unit 152, which can include a power inverter 205, rectifier 210, DC-DC converter 215, etc., or a combination thereof. The power conversion unit 152 can be an insulated-gate bipolar transistor (IGBT) module that is part of the PCS 104. The IGBT module can include an array of transistors (e.g., switching semiconductors), capacitors (e.g., filter capacitors), and any other power electronic devices to convert power. On one side of the power conversion unit 152 can be AC current and the other side DC current. The IGBT module is standard, but a variety of architectures can be used.

Power conversion system 104 further includes a heating, ventilation, and air conditioning (HVAC) equipment 153 to maintain the temperature of equipment of the PCS 104, such as the power conversion unit 152, within operating limits. The HVAC equipment 153 can include an air conditioner, such as a fan 154 and a condenser 155 to cool down the power conversion unit 152 (e.g., IGBT module). The HVAC equipment 153 can further include a heater 156.

The power conversion system 104 further includes a PCS controller 160 and environmental sensors 164A-N to protect the equipment of the PCS 104. Environmental sensors 164A-N, 370A-N can include water ingress sensors to detect water inside an enclosure of the PCS 104 or an enclosure 500 of a battery cube 230, gas sensors, particulate sensors, air sensors, or air pressure sensors. Infrared sensors can be used to detect temperature 165A, 375A such as heat inside enclosures of the PCS 104 or battery cube 230.

As shown, the PCS controller 160 includes a network communication interface 161, a processor 162, and a memory 163. The PCS 104 further includes PCS sensors 168A-N to measure a current 122 (e.g., a current magnitude) and a voltage 123 (e.g., DC link voltage). The environmental sensors 164A-N are coupled to the processor 163 and can collect environmental condition data 165A-N, for example, by measuring temperature 165A and humidity 165B inside of an enclosure of the PCS 104. The memory 163 can store the PCS data 157A-N, including the environmental condition data 165A-N collected by the environmental sensors 164A-N and the current 122 and the voltage 123 collected by PCS sensors 168A-N. The PCS data 157A-N, including the environmental condition data 165A-N, such as temperature 165A, current 122, and voltage 123 are monitored during the maintenance management protocol 400 (see FIGS. 4A-B) and acted upon to optimize a maintenance plan 397.

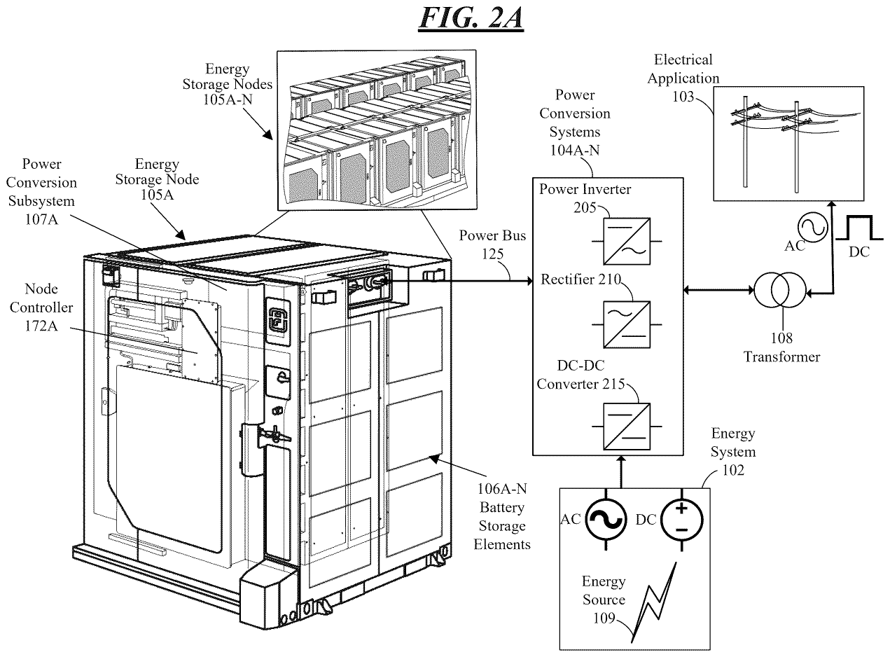

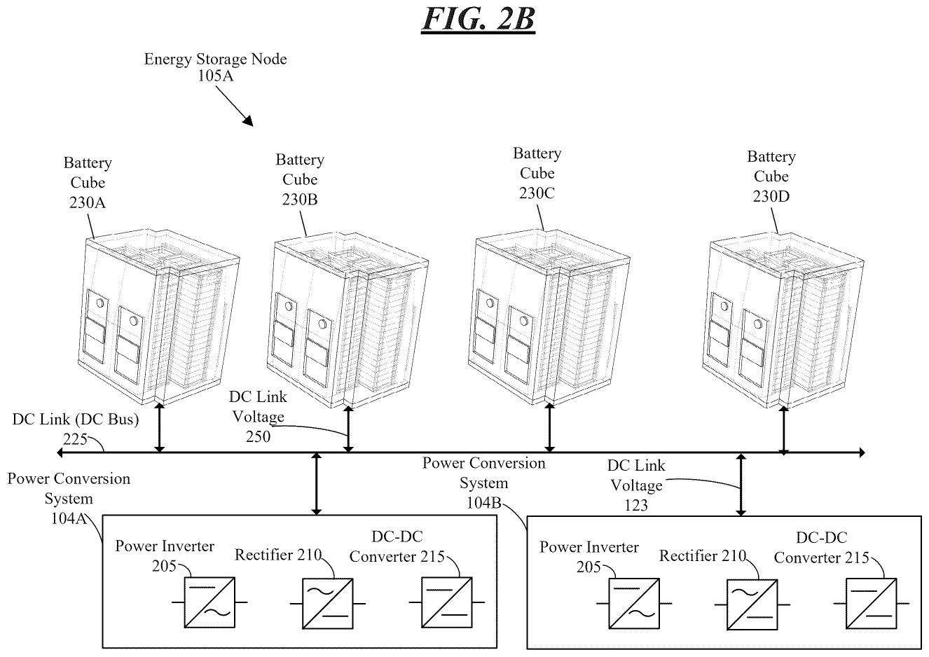

FIG. 2A illustrates a first energy storage node 105A of the plurality of energy storage nodes 105A-N of FIGS. 1A-C coupled to the electrical application 103. The first energy storage node 105A can include a single battery cube 230A (as in the case of FIG. 2A) or a plurality of battery cubes 230A-D (as in the case of FIG. 2B). Energy storage nodes 105A-N can include a battery storage element 106, a power conversion system 104 (or a power conversion subsystem 107), and a node controller 172 (or a control subsystem 110) to receive battery data 111A-N from the battery storage element 106, PCS data 157A-N from the power conversion system 104 (or the power conversion subsystem 107), or a combination thereof.

Power conversion system 104 (or the power conversion subsystem 107) can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow 112 from the energy storage system 101 from DC power into AC power during dispatch to the electrical application 103. For example, the power inverter 205 can be configured to convert power on a power bus 125 (e.g., AC bus, DC bus, or both) for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 can be distributed more locally to each of energy storage nodes 105A-N. The node controller 172 and the control subsystem 110 can be configured for local computation, processing, and control of the battery storage elements 106A-N and the power conversion subsystem 107. The control and management system 115 and the array controller 170 can be configured for more centralized computation, processing, and controls of the overall energy storage system 101, energy system 102, electrical application 103, and power conversion system 104. The various controllers 170-173 of the control and management system 115, including the array controller 170, core controllers 171A-N, node controllers 172A-N, and enclosure controllers 173A-N can include a computing device, single board computer, an application-specific integrated circuit (ASIC), microcontroller, digital signal processor (DSP), field-programmable gate array (FPGA), or a combination thereof.

FIG. 2B illustrates a first energy storage node 105A that includes a plurality of battery cubes 230A-N and a plurality of power conversion systems 104A-N coupled to a DC link (DC bus) 225. As shown, the first energy storage node 105A includes four battery cubes 230A-D and two power conversion systems 104A-B coupled to the DC link (DC bus) 225 in the example. The first energy storage node 105A can be arranged so the battery cubes 230A-B are connected to a DC bus 225A with the PCS 104A in a split bus architecture. Battery cubes 230C-D can be connected to a DC bus 225B with the PCS 104B also in a split bus architecture. Battery sensors 375A-N can measure a DC link voltage 250 of the battery cube 230B on the DC bus 225A. PCS sensors 168A-N can measure a DC link voltage 123 of the PCS 104B on the DC bus 225B.

FIG. 3A is a high-level functional block diagram of the energy storage system 101 of FIG. 1A that depicts components of the control and management system 115 and the control subsystem 110 for optimizing maintenance of the energy storage system 101. FIG. 3B is another high-level functional block diagram of the energy storage system of FIGS. 1B-C that depicts components of the control and management system 115 with various controllers 170-173 for optimizing maintenance of the energy storage system 101.

Referring to FIGS. 3A-B, as shown, each of the plurality of energy storage nodes 105A-N can include a battery storage element 106A-N; a power conversion subsystem 107; and a control subsystem 110 (FIG. 3A) or a node controller 172 (FIG. 3B) to receive battery data 111A-N from the battery storage element 106A-N, PCS data 157A-N from the power conversion subsystem 107, or a combination thereof. The control and management system 115 can be coupled to the energy storage nodes 105A-N and PCS 104 and configured to receive battery data 111A-N from the battery storage element 106, PCS data 157A-N from the power conversion system 104 (or power conversion subsystem 107), or a combination thereof.

The control subsystem 110; control and management system 115, including the array controller 170, core controllers 171A-N, node controllers 172A-N, and enclosure controllers 173A-N; energy storage nodes 105A-N; electrical application 103; and other components of the system 100 can be in communication over a network 305 or one or more networks 305A-N. The networks 305A-N can be a local area network 305A, wide area network 305B, or a combination thereof. For example, the control and management system 115 can be coupled via a local area network 305A to the energy storage nodes 105A-N and the electrical application 103. Alternative or additionally, the control and management system 115 can be coupled via a wide area network 305B to the energy storage nodes 105A-N and electrical application 103. Or the control and management system 115 can be coupled via a combination of networks 305A-N, such as via a local area network 305A to components of the energy storage system 101, including the energy storage nodes 105A-N, and coupled via a wide area network 305B to the electrical application 103.

An example energy storage system 101 includes a plurality of energy storage nodes 105A-N. Each of the plurality of energy storage nodes 105A-N include a battery storage element 106. The energy storage system 101 further includes a power conversion system (PCS) 104, a plurality of sensors 164A-N, 168A-N, 315A-N, 370A-N, 375A-N to detect or monitor various system data 380A-N. The system data 380A-N includes component data 381A-N from or about one or more components 104, 106-108, 152-156, 205, 210, 215 of the energy storage system 101. The component data 381A-N includes battery data 111A-N, PCS data 157A-N, or a combination thereof.

Energy storage system 101 further includes a control and management system 115. The functionality of the control and management system 115 described herein, including the maintenance management protocol 400 and maintenance management programming 330A-B, can be divided across one or more computing devices that are coupled via a network 305.

The control and management system 115 is coupled to the plurality of energy storage nodes 105A-N, the PCS 104, and the plurality of sensors 164A-N, 168A-N, 315A-N, 370A-N, 375A-N. The control and management system 115 is configured to receive the system data 380A-N and includes a non-transitory computer-readable medium 313 comprising maintenance management programming 330A. Execution of the maintenance management programming 330A by one or more processors 312 configures the control and management system 115 to receive or store the system data 380A-N. Execution of the maintenance management programming 330A by the one or more processors 312 configures the control and management system 115 to apply at least one analytical model 395A-N to the system data 380A-N to predict or identify an atypical condition 396A of a plurality of atypical conditions 396A-N relating to a weakness, damage, or a changed condition in the one or more components 104, 106-108, 152-156, 205, 210, 215 of the energy storage system 101. The atypical condition 396A can be a negative condition meaning a component is wearing out more than anticipated or a positive condition, meaning a component is wearing out slower than anticipated (e.g., lasting longer than expected).

The at least one analytical model 395A-N can include one or more mathematical classifications or representations, such as equations, that describe how parameters, such as the component data 381A-N, relates to each other over time, space, and other system data 380-N to gain insights into the one or more components 104, 106-108, 152-156, 205, 210, 215. The at least one analytical model 395A-N can include values and relations between various parameters, such as the system data 380A-N involved in forming an expression to describe the behavior, such as a weakness, damage, or a changed condition, under assumed boundary conditions of the one or more components 104, 106-108, 152-156, 205, 210, 215.

Execution of the maintenance management programming 330A by the one or more processors 312 configures the control and management system 115 to responsive to the atypical condition 396A, optimize a maintenance plan 397 for the energy storage system 101. For example, the optimization of maintenance plan 397 can change actual operation or equipment of the energy storage system 101 to reduce component wear. In addition to scheduling, optimization of the maintenance plan 397 includes choosing skillsets for maintenance whether done by a human or a robot, toolsets, a human/robot working on-site, or a human/robot working remotely. In some examples, a human operator may receive through a computer software interface an automatic computerized analysis of how to optimize the maintenance plan 397 and then enter updates, such as mitigation activities 385A-N, to the maintenance plan 397 through the computer software interface.

Optimization of the maintenance plan 397 can include scheduling maintenance of the energy storage system 101 sooner, but also changing the maintenance plan 397, such as adding or subtracting activities. For example, if a component of the energy storage system 101 is taking longer than expected to wear out and is going to perform beyond an expected lifetime (e.g., last longer than an anticipated lifetime), then maintenance might be deferred until later instead of sooner. The maintenance plan 397 can be a versioned computerized digital plan that may automatically schedule personnel or robots for activities, such as to schedule maintenance; and order components for replacement. However, in some examples, the maintenance plan 397 can be a paper-based filing system. The maintenance plan 397 can schedule downtime with third parties. There is also diversity in commercial models where the maintenance plan 397 is held by customer, manufacturer of the energy storage system 101, a contractor of a customer, or a contractor of the manufacturer.

The applying at least one analytical model 395A-N to the system data 380A-N to predict or identify the atypical condition 396A can include the following. First, feeding the component data 381A-N into the at least one analytical model 395A-N. Second, holding the component data 381A-N over one or more time periods 398A-N. Third, matching the component data 381A-N over the one or more time periods 398A-N against atypical condition patterns 399A-N previously identified as being associated with weakness, damage, or a changed condition relating to an extended lifetime of the one or more components 104, 106-108, 152-156, 205, 210, 215.

System data 380A-N pulled of the PCS 104 to determine the PCS 104 is weakened or damaged or conversely lasting longer than expected lifetime can include temperature 165A, current 122, and voltage 123. These are key pieces of data fed into the at least one analytical model 395A-N. In addition to absolute values of the temperature 165A, current 122, and voltage 123, the nature of waveforms and profile of the signals are processed in the analytical models 395A-N. The signal processing in the analytical models 395A-N can hold measurements of the system data 380A-N over time, create a profile, and match against atypical condition patterns 399A-N previously identified as being associated with weakened or damaged components of the PCS 104 or an extended lifetime.

The level of granularity on the PCS 104 depends on resolution of sensors 164A-N, 168A-N, for example sensing how long it takes an electrical contact to open and close under certain conditions and how that changes over time. PCS sensors 168A-N and environmental sensors 164A-N can sense temperature 165A, current 122, and voltage 123 and monitor for change and known good or bad behaviors coupled with operating conditions. In addition to the absolute temperature 165A, current 122, and voltage 123, the relationship between is analyzed. When the DC voltage behaves in a certain way, then the AC voltage behaves a certain way which may change depending on temperature 165A. When the DC current behaves a certain way, then the AC current behaves a certain way which may change depending on temperature 165A, voltage 122, etc. The analytical models 395A-N can include electrical or machine learning models in which the relationship between signals derived from the system data 380A-N are used to make a determination of what is a normal condition versus an atypical condition 396A-N.

The atypical condition 396A can relate to weakness or damage in the one or more components 104, 106-108, 152-156, 205, 210, 215. The optimizing the maintenance plan 397 can include adjusting the maintenance plan 397 for the energy storage system 101 with a mitigation activity 385 to fix or avoid a continuing deteriorating condition of the one or more components 104, 106-108, 152-156, 205, 210, 215.

In some examples, the mitigation activity 385 adjusts operation of the one or more components 104, 106-108, 152-156, 205, 210, 215 to reduce rate of component wear, schedules earlier maintenance of the one or more components 104, 106-108, 152-156, 205, 210, 215; schedules deferred maintenance of the one or more components 104, 106-108, 152-156, 205, 210, 215; orders or reserves spares of the one or more components 104, 106-108, 152-156, 205, 210, 215; or increases an amount of spares of the one or more components 104, 106-108, 152-156, 205, 210, 215.

Example analytical models 395A-N can look at the relationship between DC and AC sides of the PCS 104. If there appears to be poor behavior, some of the mitigation activities 385A-N to update the maintenance plan 397 may be to proactively replace a component, increase amount of spares kept on site for a component (e.g., may not actually replace, but increase spares if behavior is marginal), order or reserve spares in a centralized warehouse (e.g., adjust spares management), service a supporting component (e.g., if the temperature profile looks marginal, then change filters ahead of schedule, which is a simple rescheduling as opposed to a replacement or spares management). The maintenance management programing 330A-B and analytical models 395A-N can incorporate external factors, such as a weather forecast, when optimizing the maintenance plan 397. For example, based on an anomaly detection, the maintenance management programing 330A-B can examine the weather forecast to adjust based on practicality, such as not sending personnel on-site during a blizzard or when weather conditions call for cooler conditions in the month of October because there would be less wear and tear on components as the weather changes.

Atypical conditions 396A-N can be identified in variety of components, including batteries 106A-N, PCS 104, transformer 108, thermal and environmental management systems (e.g., HVAC equipment 153, chillers, AC units for cooling, etc.). For example, the one or more components of the energy storage system can include the power conversion system 104, the battery storage element 106, a transformer 108, HVAC equipment 153, or a power inverter 205. For a transformer 108 component, the analytical models 395A-N can include a temperature analysis, oil composition analysis, an AC waveform analysis on the low side and high side, such as phase imbalances, etc. The optimization of the maintenance plan 397 for the transformer 108 can include mitigation activities 385A-N that are similar to the PCS 104: spare management, scheduling more frequent fluid check analysis, torquing of connections, etc.

For a battery storage element 106, the analytical models 395A-N can analyze primarily voltage 116A, current 116B, and temperature 116C. The analytical models 395A-N can examine the battery storage element 106 at many or all levels, including cell, module, rack, and node level to determine whether there are normal characteristics at each particular level or atypical conditions 396A-N.

Optimization of the maintenance plan 397 can include changing a replacement schedule for battery storage elements 106A-N. The maintenance plan 397 can include specifications for replacement components the specification for replacement can be changed. Hence, optimization of the maintenance plan 397 can include ordering the same type of battery or revising replacement components, such as a different type of battery to improve performance and anticipated lifetime. For example, ordering a different battery from a different manufacturer, requesting modification to change a composition of an electrolyte, etc. Alternatively or additionally, optimization of the maintenance plan 397 can include determining to replace a component more or less frequently based on a cost tradeoff of changing the component with an alternative option that is more or less expensive. For example, if a bolt is frequently replaced and not for quality reasons, then changing the specification of the bolt to a cheaper option would be an optimization.

The PCS data 157A-N can include environmental condition data 165A-N, such as a temperature 165A; a current 122; a voltage 123; or a combination thereof. The battery data 111A-N can include a voltage 111A, a current 111B, a temperature 111C, or a combination thereof. A variety of conditions can be used to identify the atypical condition 396A for maintenance purposes, including: a state of charge 116A, a temperature, a power capability, remaining energy capacity, an internal resistance or impedance, a degradation of a cathode active material, a degradation of an anode active material, a degree of growth of a solid-electrode interphase (SEI) layer, remaining lithium inventory/lithium inventory loss, lithium plating on an anode or a cathode active material, a lithium dendrite growth on an anode active material, depositing of electrode decomposition products on an anode or a cathode active material, a current distribution non-uniformity in an anode or a cathode active material, a phase of a cathode active material, a phase of an anode active material, or a combination thereof.

Control and management system 115 of FIG. 3A and array controller 170 of FIG. 3B include a network communication interface 311 configured for wired or wireless communication over the network 305. The control and management system 115 and the array controller 170 further include a memory 313, and a processor 312 coupled to the network communication interface 311 and the memory 313. As shown, the memory 313 of the control and management system 115 and the array controller 170 is configured to store maintenance management programming 330A; a required power flow 112; battery conditions 116A-O (including a state of charge 116A); power commands 183A-N; analytical models 395A-N; atypical conditions 396A-N; system data 380A-N, including component data 381A-N, such as battery data 111A-N, environmental condition data 365A-N from the energy storage nodes 105A-N, and PCS data 157A-N (including the environmental condition data 165A-N from the PCSs 104A-N); a maintenance plan 397 that includes mitigation activities 385A-N; time periods 398A-N; and atypical condition patterns 399A-N. The control and management system 115 and the array controller 170 can also include sensors 315A-N coupled to the processor 312 to detect or monitor various system parameters, such as power, temperature, voltage, current, resistance, and/or impedance. For example, the sensors 315A-N, battery sensors 375A-N can be coupled to the power bus 125 and the DC link (DC bus) 225.

Control and management system 115 and the array controller 170 can be configured to receive or store a required power flow 112 or a power capacity for an electrical application 103 and to dispatch the required power flow 112 across the plurality of energy storage nodes 105A-N. The required power flow 112 can include an active power (e.g., measured in kW or mW), a reactive power (e.g., measured in kVARs), or a total system power discharge or charge requirement. The required power flow 112 can be a power command 183 for the electrical application 103 based on a customer or independent system operator request received over the network 305 from the electrical application 103, in which case the power command 183 is externally determined. The power capacity can be apparent power (e.g., kVA or MVA), such as name plate capacity measured in volt-amperes that can be used for power electronics or electronic equipment to define capabilities in terms of overall power. Both active power and reactive power come together to form apparent power and manufacturers define the capability of the power capacity of power electronics equipment based on the apparent power.

The power command 183 for the electrical application 103 can be based on parameters in a customer or independent system operator request received over the network 305 from the electrical application 103. For example, the parameters can be to provide frequency regulation with a deadband and a slope of the response. The control and management system 115 can take the parameters and attempt to determine the power command 183, for example, based on satisfying the customer or independent system operator request for the electrical application 103.

Control and management system 115 can take the required power flow 112 needed for the electrical application 103, for example, as requested by a customer or software application and determine the optimal way to distribute the required power flow 112 across all of the energy storage nodes 105A-N. This optimization may be conducted in several manners, for example using traditional operational optimization techniques or machine-learning based techniques. The control and management system 115 can include one or more processors, controllers, or computing devices that can be configured to perform closed loop management of real and reactive power supplied to the electrical application 103.

Energy storage nodes 105A-N include a control subsystem 110 in FIG. 3A and a node controller 172 in FIG. 3B, battery storage elements 106A-N, and a power conversion subsystem 107 (or a power conversion system 104), which can reside on each individual energy storage node 105A-N. The control subsystem 110 and the node controller 172 of the energy storage nodes 105A-N include a network communication interface 351 configured for wired or wireless communication over the network 305. The control subsystem 110 and the node controller 172 further include a memory 353, and a processor 352 coupled to the network communication interface 351 and the memory 353. As shown, the memory 353 of the control subsystem 110 and the node controller 172 is configured to store maintenance management programming 330B, battery data 111A-N, battery conditions 116A-O (including a state of charge 116A), and environmental condition data 165A-N, 365A-N.

The control subsystem 110 and the node controller 172 further include environmental sensors 370A-N and battery sensors 375A-N coupled to the processor 352. Environmental sensors 370A-N can collect environmental condition data 365A-N, for example, by measuring humidity and temperature inside of an enclosure 500 of the energy storage nodes 105A-N, such as one or more battery cubes 230A-N. Battery sensors 375A-N can include a voltage sensor 375A, a current sensor 375B, and a temperature sensor 375C to measure readings of battery data 111A-N, such as a voltage 111A, a current 111B, a temperature 111C, or other physical phenomena occurring within the battery storage elements 106A-N. The memory 353 can store the environmental condition data 365A-N collected by the environmental sensors 370A-N and the battery data 111A-N measured by the battery sensors 375A-N.

The control subsystem 110 or the control and management system 115 is configured to determine at least one battery condition 116A-O about one or more of the energy storage nodes 105A-N from the battery data 111A-N. The battery conditions 116A-O can be algorithmically determined estimates from battery data 111A-N, readings from the sensors 315A-N, battery sensors 375A-N that monitor various system parameters on the power bus 125, DC link (DC bus) 225, or a combination thereof, for example. State estimating algorithms can take the measured readings of battery data 111A-N, including the voltage 111A, the current 111B, the temperature 111C, or a combination thereof as input parameters and estimate the battery conditions 116A-O based on the battery data 111A-N.

For example, a state of charge 116A is a state estimate derived from the voltage 111A and the current 111B readings. The state of charge 116A can be derived from the control and management system 115. Alternatively or additionally, at least one battery management system (BMS) or the node controller 172 can derive the state of charge 116A. The state of charge 116A can be determined for a first energy storage node 105A that includes a plurality of battery cubes 230A-N. The control subsystem 110 can include at least one battery management systems (BMS). For example, the SOC 116A can be determined for an entire energy storage node 105A-N (e.g., a first energy storage node 105A including all seven battery cubes 230A-G of all battery storage elements 106A-N behind the first energy storage node 105A). SOC calculations may look at voltage on the DC bus 225 over time. The SOC 116A can be a calculated number of all battery cubes 230A-G put together on that first energy storage node 105A based on how much current is being put through and how much energy can get out. The SOC 116A can be one parameter reading for an entire DC bus 225 for the first energy storage node 105A.

Some state estimating algorithms may receive measured readings from the battery sensors 375A-N of the control subsystem 110 and sensors 315A-N of the control system 115 to derive other parameters, such as real time power. For example, real time power may be derived as a parameter in order to determine the battery conditions 116A-O.

The SOC 116A provided by a battery management system, for example, can be based on Coulombe counting and be a number from 0-100% as to whether a first energy storage node 105A is full or empty. The SOC 116A can be provided at the node level for all of the battery cubes 230A-N on that DC bus 225. Each battery rack of a battery cube 230 can have a BMS and that information can be propagated to a system level BMS to determine the SOC 116A of all of the battery cubes 230A-N, as opposed to each individual battery cube 230 or each battery cell in the battery cube 230.

The control and management system 115 and the array controller 170 can manage power commands 183A-N to the control subsystem 110 and the node controller 172 respectively, to charge or discharge the plurality of energy storage nodes 105A-N based on the required power flow 112. For example, the control and management system 115 and the array controller 170 can send the power commands 183A-N based on the total required power flow 112 to the plurality of energy storage nodes 105A-N. Alternatively or additionally, the control subsystem 110 and the node controller 172 can issue the power commands 183A-N directly at the plurality of energy storage nodes 105A-N based on the required power flow 112.

FIG. 3C is a block diagram of the control system 115 depicting various types of battery conditions 116A-O to implement the maintenance management protocol 400 of FIGS. 4A-B. As shown, the atypical condition 396A-N can include a battery condition 116A-O. The at least one battery condition can include: a state of charge 116A, a temperature 116B, a power capability 116C, remaining energy capacity 116D, an internal resistance or impedance 116E, a degradation of a cathode active material 116F, a degradation of an anode active material 116G, a degree of growth of a solid-electrode interphase (SEI) layer 116H, remaining lithium inventory/lithium inventory loss 116I, lithium plating on an anode or a cathode active material 116J, a lithium dendrite growth on an anode active material 116K, depositing of electrode decomposition products on an anode or a cathode active material 116L, a current distribution non-uniformity in an anode or a cathode active material 116M, a phase of a cathode active material 116N, a phase of an anode active material 116O, or a combination thereof. The battery conditions 116A-O can be used to determine atypical conditions 396A-N.

The battery conditions 116A-O can be determined by applying power pulse patterns during charging or can discharging cycles that include a higher frequency charge or discharge swing. In an example, the power pulse pattern during battery charging can include to charge to a first voltage for a first period of time, stop charging for a second period of time, then charge to a second voltage for a third period of time, stop charging for a fourth period of time, and then charge to a third voltage for a fifth period of time. The power pulse pattern during battery discharging can include to discharge to a first voltage for a first period of time, stop discharging for a second period of time, then discharge to a second voltage for a third period of time, stop discharging for a fourth period of time, and then discharge to a third voltage for a fifth period of time. The voltages and timing (e.g., periods of time) of the power pulse patterns can be adjusted during the charging and discharging cycles to provide a set of battery data 111A-N to feed the state estimating algorithms in order to determine the battery conditions 116A-O.

FIG. 4A is an maintenance management protocol 400 for the energy storage system 101 of FIG. 1A that is implemented by the control and management system 115, the control subsystem 110, and the plurality of energy storage nodes 105A-N. In the example of FIG. 4A, the maintenance management protocol 400 can be implemented in the maintenance management programming 330A of the control and management system 115 and the maintenance management programming 330B of the control subsystem 110.

FIG. 4B is the maintenance management protocol 400 for the energy storage system 101 of FIGS. 1B-C that is implemented by the various controllers 170-173 of the control and management system 115, and the plurality of energy storage nodes 105A-N. In the example of FIG. 4B, the maintenance management protocol 400 can be implemented in the maintenance management programming 330A of the array controller 170 and the maintenance management programming 330B of the node controller 172.

Referring to both FIGS. 4A-B, execution of maintenance management programming 330A stored in a memory 313 by a processor 312 of the control and management system 115 (e.g., array controller 170) configures the control and management system 115 (e.g., array controller 170) to implement blocks 405, 410, and 415 described below. Execution of maintenance management programming 330B stored in a memory 353 by a processor 352 of the control subsystem 110 (e.g., node controller 172) can configure the control subsystem 110 (e.g., node controller 172) to implement some portion or all of blocks 405, 410, and 415 described below. More generally, the execution of the maintenance management programming 330A-B by one or more processors 312, 352 can configure one or more controllers 110, 115, 170-173 to implement blocks 405, 410, and 415 below.

Beginning in block 405, the maintenance management protocol 400 includes to receive or store system data 380A-N. The system data 380A-N includes component data 381A-N from or about one or more components 104, 106-108, 152-156, 205, 210, 215 of the energy storage system 101. The component data 381A-N can include battery data 111A-N, PCS data 157A-N, or a combination thereof.

Moving now to block 410, the maintenance management protocol 400 further includes to apply at least one analytical model 395A-N to the system data 380A-N to predict or identify an atypical condition 396A of a plurality of atypical conditions 396A-N relating to a weakness, damage, or a changed condition in the one or more components 104, 106-108, 152-156, 205, 210, 215 of the energy storage system 101.

The applying at least one analytical model 395A-N to the system data 380A-N to predict or identify the atypical condition 396A can include: feeding the component data 381A-N into the at least one analytical model 395A-N; holding the component data 381A-N over one or more time periods 398A-N; and matching the component data 381A-N over the one or more time periods 398A-N against atypical condition patterns 399A-N previously identified as being associated with weakness, damage, or a changed condition relating to an extended lifetime of the one or more components 104, 106-108, 152-156, 205, 210, 215.

Finishing now in block 415 the maintenance management protocol 400 can further include responsive to the atypical condition, optimize a maintenance plan 397 for the energy storage system 101. The atypical condition 396A can relate to weakness or damage in the one or more components 104, 106-108, 152-156, 205, 210, 215. The optimizing the maintenance plan 397 can include adjusting the maintenance plan 397 for the energy storage system 101 with a mitigation activity 385 to fix or avoid a continuing deteriorating condition of the one or more components 104, 106-108, 152-156, 205, 210, 215. For example, the mitigation activity 385 adjusts operation of the one or more components 104, 106-108, 152-156, 205, 210, 215 to reduce rate of component wear; schedules earlier maintenance of the one or more components 104, 106-108, 152-156, 205, 210, 215; schedules deferred maintenance of the one or more components 104, 106-108, 152-156, 205, 210, 215; orders or reserves spares of the one or more components 104, 106-108, 152-156, 205, 210, 215; or increases an amount of spares of the one or more components 104, 106-108, 152-156, 205, 210, 215. The one or more components of the energy storage system 101 can include the power conversion system 104, the battery storage element 106, a transformer 108, HVAC equipment 153, or a power inverter 205. The PCS data 157A-N can include environmental condition data 165A-N, a temperature 165A, a current 122, a voltage 123, or a combination thereof.

The battery data 111A-N can include a voltage 111A, a current 111B, a temperature 111C, or a combination thereof. The atypical condition 396A-N can include a battery condition 116A-O. The battery condition 116A-O can comprise: a state of charge 116A, a temperature 116B, a power capability 116C, remaining energy capacity 116D, an internal resistance or impedance 116E, a degradation of a cathode active material 116F, a degradation of an anode active material 116G, a degree of growth of a solid-electrode interphase (SEI) layer 116H, remaining lithium inventory/lithium inventory loss 116I, lithium plating on an anode or a cathode active material 116J, a lithium dendrite growth on an anode active material 116K, depositing of electrode decomposition products on an anode or a cathode active material 116L, a current distribution non-uniformity in an anode or a cathode active material 116M, a phase of a cathode active material 116N, a phase of an anode active material 116O, or a combination thereof.

In FIG. 4A, the local control subsystem 110 or the control and management system 115 can implement a subset or all of the blocks 405, 410, and 415 of the maintenance management protocol 400 without the central control and management system 115. In some examples, the functionality of the control and management system 115 and the maintenance management programming 330A-B can be separated into one or more controllers or computing devices. For example, blocks 405, 410, and 415 can be implemented in one or more separate computing devices that implement a digital maintenance management system which is separate from the control system. The maintenance management programming 330A-B may be stored and executed on the one or more controllers or computing devices.

In FIG. 4B, the core controllers 171A-N, node controllers 172A-N, and enclosure controllers 173A-N can implement a subset or all of the blocks 405, 410, and 415 of the maintenance management protocol 400 without the central array controller 170. In some examples, the functionality of the array controller 170 and the maintenance management programming 330A-B can be separated into one or more controllers or computing devices. For example, blocks 405, 410, and 415 can be implemented in one or more computing devices that implement a digital maintenance management system which is separate from the controllers 170-174. The maintenance management programming 330A-B may be stored and executed on the one or more controllers or computing devices.

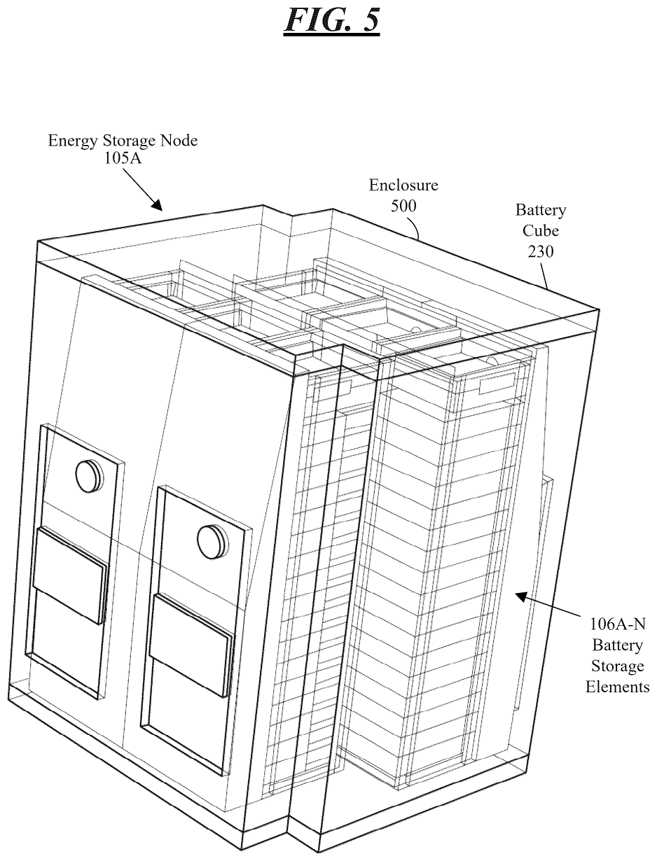

FIG. 5 is a cutaway view of the first energy storage node 105A of the plurality of energy storage nodes 105A-N and shows details of a plurality of battery storage elements 106A-N. As shown, the energy storage node 105A includes an enclosure 500, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 5, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

Each of the energy storage nodes 105A-N can include a collection of one or more enclosures 500A-N like that shown in FIG. 5 that house a plurality of battery storage elements 106A-N packaged together as a battery cube 230 in the example. Of course, the enclosure 500 can be shaped in a variety of other form factors. Each of the battery cubes 230A-N can further include a respective enclosure controller 173A-N that is controlled by a respective node controller 172A-N as part of the control and management system 115.

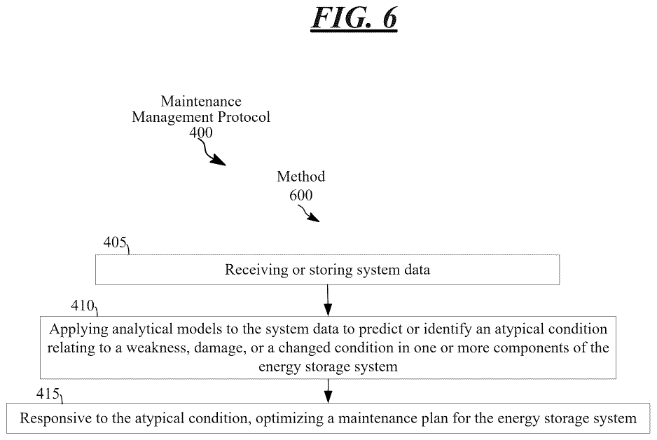

FIG. 6 is a flowchart of a method 600 that can be implemented for optimizing maintenance of the energy storage system 100. In the example of FIG. 6, the method 600 implements the maintenance management protocol 400 of FIG. 4. Beginning in step 605, the method 600 includes receiving or storing system data 380A-N. The system data 380A-N includes component data 381A-N from or about one or more components 104, 106-108, 152-156, 205, 210, 215 of the energy storage system 101. The component data 381A-N can include battery data 111A-N, PCS data 157A-N, or a combination thereof.

Continuing to step 610, the method 600 further includes applying at least one analytical model 395A-N to the system data 380A-N to predict or identify an atypical condition 396A of a plurality of atypical conditions 396A-N relating to a weakness, damage, or a changed condition in the one or more components 104, 106-108, 152-156, 205, 210, 215 of the energy storage system 101. The applying at least one analytical model 395A-N to the system data 380A-N to predict or identify the atypical condition 396A can include: feeding the component data 381A-N into the at least one analytical model 395A-N; holding the component data 381A-N over one or more time periods 398A-N; and matching the component data over the one or more time periods 398A-N against atypical condition patterns 399A-N previously identified as being associated with weakness, damage, or a changed condition relating to an extended lifetime of the one or more components 104, 106-108, 152-156, 205, 210, 215.

Finishing now in step 615, the method 600 further includes responsive to the atypical condition 396A, optimizing a maintenance plan 397 for the energy storage system 101. The atypical condition 396A can relate to weakness or damage in the one or more components 104, 106-108, 152-156, 205, 210, 215. The optimizing the maintenance plan 397 includes adjusting the maintenance plan 397 for the energy storage system 101 with a mitigation activity 385 to fix or avoid a continuing deteriorating condition of the one or more components 104, 106-108, 152-156, 205, 210, 215. For example, the mitigation activity 385 adjusts operation of the one or more components 104, 106-108, 152-156, 205, 210, 215 to reduce rate of component wear; schedules earlier maintenance of the one or more components 104, 106-108, 152-156, 205, 210, 215; schedules deferred maintenance of the one or more components 104, 106-108, 152-156, 205, 210, 215; orders or reserves spares of the one or more components104, 106-108, 152-156, 205, 210, 215; or increases an amount of spares of the one or more components 104, 106-108, 152-156, 205, 210, 215. The one or more components of the energy storage system include the power conversion system 104, the battery storage element 106, a transformer 108, HVAC equipment 153, or a power inverter 205. The PCS data 157A-N can include environmental condition data 165A-N, a temperature 165A, a current 122, a voltage 123, or a combination thereof.

In the examples above, the energy system 102, energy application 103, power conversion system 104, energy storage nodes 105A-N, control subsystem 110, control and management system 115, array controller 170, core controllers 171A-N, node controllers 172A-N, enclosure controllers 173A-N, etc. each include a network communication interface 161, 311, 351 for wired or wireless communication over one or more networks 305A-N. The networks 305A-N interconnect the links to/from the network communication interfaces 161, 311, 351 of the devices, so as to provide data communications amongst the energy application 103, energy storage nodes 105A-N, control and management system 115, array controller 170, core controllers 171A-N, node controllers 172A-N, enclosure controllers 173A-N, etc. Networks 305A-N may support data communication by equipment at the premises via wired (e.g., cable or fiber) media or via wireless (e.g., Wi-Fi, Bluetooth™, ZigBee, LiFi, IrDA, etc.) or combinations of wired and wireless technology.

Any of the functionality of the maintenance management protocol 400, including maintenance management programming 330A-B, described herein for the energy system 102, electrical application 103, power conversion system 104, energy storage nodes 105A-N, control subsystem 110, control and management system 115, array controller 170, core controllers 171A-N, node controllers 172A-N, enclosure controllers 173A-N, etc. can be embodied in one or more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the energy system 102, energy application 103, power conversion system 104, energy storage nodes 105A-N, control subsystem 110, control and management system 115, array controller 170, core controllers 171A-N, node controllers 172A-N, enclosure controllers 173A-N, etc. can each include a processor. As used herein, a processor 162, 312, 352 is a hardware circuit having elements structured and arranged to perform one or more processing functions, typically various data processing functions. Although discrete logic components could be used, the examples utilize components forming a programmable central processing unit (CPU). A processor 162, 312, 352 for example includes or is part of one or more integrated circuit (IC) chips incorporating the electronic elements to perform the functions of the CPU. The processors 162, 312, 352 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 162, 312, 352 can include one microprocessor or a multi-processor architecture. A digital signal processor (DSP) or field-programmable gate array (FPGA) could be suitable replacements for the processors 162, 312, 352, but may consume more power with added complexity.

The applicable processor 162, 312, 352 executes programming or instructions to configure the energy system 102, energy application 103, power conversion system 104, energy storage nodes 105A-N, control subsystem 110, control and management system 115, array controller 170, core controllers 171A-N, node controllers 172A-N, enclosure controllers 173A-N, etc. to perform various operations. For example, such operations may include various general operations (e.g., a clock function, recording and logging operational status and/or failure information) as well as various system-specific operations (e.g., energy management) functions. Although a processor 162, 312, 352 may be configured by use of hardwired logic, typical processors are general processing circuits configured by execution of programming, e.g., instructions and any associated setting data from the memories 163, 313, 353 shown or from other included storage media and/or received from remote storage media.

In the examples above, the energy system 102, energy application 103, power conversion system 104, energy storage nodes 105A-N, control subsystem 110, control and management system 115, array controller 170, core controllers 171A-N, node controllers 172A-N, enclosure controllers 173A-N, etc. each include a memory. The memory 163, 313, 353 may include a flash memory (non-volatile or persistent storage), a read-only memory (ROM), and a random access memory (RAM) (volatile storage). The RAM serves as short term storage for instructions and data being handled by the processors 162, 312, 352 e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the maintenance management protocol 400 and the maintenance management programming 330A-B. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the maintenance management protocol 400 and the maintenance management programming 330A-B, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 162, 312, 352 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the maintenance management protocol 400 and the maintenance management programming 330A-B, the programming or software can be stored in a computer program product or non-transitory computer readable medium and loaded into the computing device using a removable storage drive or communications interface. In an exemplary embodiment, any computing device, such as control subsystem 110, control and management system 115 and controllers 170-173, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. An energy storage system, comprising:
a plurality of energy storage nodes, wherein the plurality of energy storage nodes include a battery storage element;
a power conversion system (PCS);
a plurality of sensors to detect or monitor various system data, wherein the system data includes component data from or about one or more components of the energy storage system, the component data including battery data, PCS data, or a combination thereof; and
a control and management system coupled to the plurality of energy storage nodes, the PCS, and the plurality of sensors and configured to receive the system data, the control and management system including a non-transitory computer-readable medium, comprising maintenance management programming, wherein execution of the maintenance management programming by one or more processors configures the control and management system to:
receive or store the system data;
apply analytical models to the system data to predict or identify an atypical condition relating to a weakness, damage, or a changed condition in the one or more components of the energy storage system; and
responsive to the atypical condition, optimize a maintenance plan for the energy storage system.

2. The energy storage system of claim 1, wherein the applying analytical models to the system data to predict or identify the atypical condition includes:
feeding the component data into an atypical condition model;
holding the component data over one or more time periods; and
matching the component data over the one or more time periods against atypical condition patterns previously identified as being associated with weakness, damage, or a changed condition relating to an extended lifetime of the one or more components.

3. The energy storage system of claim 1, wherein:
the atypical condition relates to weakness or damage in the one or more components;
the optimizing the maintenance plan includes adjusting the maintenance plan for the energy storage system with a mitigation activity to fix or avoid a continuing deteriorating condition of the one or more components.

4. The energy storage system of claim 3, wherein the mitigation activity adjusts operation of the one or more components to reduce rate of component wear, schedules earlier maintenance of the one or more components, schedules deferred maintenance of the one or more components, orders or reserves spares of the one or more components, or increases an amount of spares of the one or more components.

5. The energy storage system of claim 1, wherein the one or more components of the energy storage system include the battery storage element, the power conversion system, a transformer, or HVAC equipment.

6. The energy storage system of claim 1, wherein:
the PCS data includes environmental condition data, a voltage, a current, a temperature, or a combination thereof.

7. The energy storage system of claim 1, wherein:
the battery data includes a voltage, a current, a temperature, or a combination thereof; and
the atypical condition includes a battery condition, wherein the battery condition comprises: a state of charge, a temperature, a power capability, remaining energy capacity, an internal resistance or impedance, a degradation of a cathode active material, a degradation of an anode active material, a degree of growth of a solid-electrode interphase (SEI) layer, remaining lithium inventory/lithium inventory loss, lithium plating on an anode or a cathode active material, a lithium dendrite growth on an anode active material, depositing of electrode decomposition products on an anode or a cathode active material, a current distribution non-uniformity in an anode or a cathode active material, a phase of a cathode active material, a phase of an anode active material, or a combination thereof.

8. A non-transitory computer-readable medium, comprising maintenance management programming, wherein execution of the maintenance management programming by one or more processors configures one or more controllers to:
receive or store system data, wherein the system data includes component data from or about one or more components of an energy storage system, the component data including battery data, power conversion system (PCS) data, or a combination thereof;
apply analytical models to the system data to predict or identify an atypical condition relating to a weakness, damage, or a changed condition in the one or more components of the energy storage system; and
responsive to the atypical condition, optimize a maintenance plan for the energy storage system.

9. The non-transitory computer-readable medium of claim 8, wherein the applying analytical models to the system data to predict or identify the atypical condition includes:
feeding the component data into an atypical condition model;
holding the component data over one or more time periods; and
matching the component data over the one or more time periods against atypical condition patterns previously identified as being associated with weakness, damage, or a changed condition relating to an extended lifetime of the one or more components.

10. The non-transitory computer-readable medium of claim 8, wherein:
the atypical condition relates to weakness or damage in the one or more components;
the optimizing the maintenance plan includes adjusting the maintenance plan for the energy storage system with a mitigation activity to fix or avoid a continuing deteriorating condition of the one or more components.

11. The non-transitory computer-readable medium of claim 10, wherein the mitigation activity adjusts operation of the one or more components to reduce rate of component wear, schedules earlier maintenance of the one or more components, schedules deferred maintenance of the one or more components, orders or reserves spares of the one or more components, or increases an amount of spares of the one or more components.

12. The non-transitory computer-readable medium of claim 8, wherein the one or more components of the energy storage system include the battery storage element, the power conversion system, a transformer, or HVAC equipment.

13. The non-transitory computer-readable medium of claim 8, wherein:
the PCS data includes environmental condition data, a voltage, a current, a temperature, or a combination thereof.

14. The non-transitory computer-readable medium of claim 8, wherein:
the battery data includes a voltage, a current, a temperature, or a combination thereof; and
the atypical condition includes a battery condition, wherein the battery condition comprises: a state of charge, a temperature, a power capability, remaining energy capacity, an internal resistance or impedance, a degradation of a cathode active material, a degradation of an anode active material, a degree of growth of a solid-electrode interphase (SEI) layer, remaining lithium inventory/lithium inventory loss, lithium plating on an anode or a cathode active material, a lithium dendrite growth on an anode active material, depositing of electrode decomposition products on an anode or a cathode active material, a current distribution non-uniformity in an anode or a cathode active material, a phase of a cathode active material, a phase of an anode active material, or a combination thereof.

15. A method, comprising:
receiving or storing system data, wherein the system data includes component data from or about one or more components of the energy storage system, the component data including battery data, PCS data, or a combination thereof;
applying at least one analytical model to the system data to predict or identify an atypical condition of a plurality of atypical conditions relating to a weakness, damage, or a changed condition in the one or more components of the energy storage system; and
responsive to the atypical condition, optimizing a maintenance plan for the energy storage system.

16. The method of claim 15, wherein the applying at least one analytical model to the system data to predict or identify the atypical condition includes:
feeding the component data into the at least one analytical model;
holding the component data over one or more time periods; and
matching the component data over the one or more time periods against atypical condition patterns previously identified as being associated with weakness, damage, or a changed condition relating to an extended lifetime of the one or more components.

17. The method of claim 15, wherein:
the atypical condition relates to weakness or damage in the one or more components; and
the optimizing the maintenance plan includes adjusting the maintenance plan for the energy storage system with a mitigation activity to fix or avoid a continuing deteriorating condition of the one or more components.

18. The method of claim 17, wherein the mitigation activity adjusts operation of the one or more components to reduce rate of component wear, schedules earlier maintenance of the one or more components, schedules deferred maintenance of the one or more components, orders or reserves spares of the one or more components, or increases an amount of spares of the one or more components.

19. The method of claim 15, wherein the one or more components of the energy storage system include the power conversion system, the battery storage element, a transformer, or HVAC equipment.

20. The method of claim 15, wherein:
the PCS data includes environmental condition data, a temperature, a current, a voltage, or a combination thereof.
